(19) United States
(12) Patent Application Publication
(10) Pub. No.: US 2016/0071156 A1
(43) Pub. Date: Mar. 10, 2016

(54) INFORMATION PROCESSING METHOD AND DEVICE

(71) Applicant: TENCENT TECHNOLOGY (SHENZHEN) COMPANY LIMITED, Shenzhen (CN)

(72) Inventors: Huorong LI, Shenzhen (CN); Kexiao Duan, Shenzhen (CN); Ke Fan, Shenzhen (CN); Lijuan Zhao, Shenzhen (CN); Yi Wen, Shenzhen (CN); Jianwei Deng, Shenzhen (CN); Songjian Wang, Shenzhen (CN); Ningguo Chen, Shenzhen (CN); Qiang Fei, Shenzhen (CN)

(21) Appl. No.: 14/613,114

(22) Filed: Feb. 3, 2015

(30) Foreign Application Priority Data
Sep. 4, 2014 (CN) 201410449762.X

(51) Int. Cl. G06Q 30/02; G06Q 20/32

(52) U.S. Cl. CPC G06Q 30/0267; G06Q 20/322

(57) ABSTRACT

It is described an information processing method. On a display screen of a terminal it is presented at least one piece of promotion information associated with an application when the application is running on the terminal. Upon detecting that one piece of the promotion information is selected, a payment platform which is in-built in the application is triggered to perform the following: requesting a server to determine whether a payment option corresponding to the selected piece of the promotion information shall be presented on a first page or a second page; jumping to the first page upon reception from the server of a first operation instruction of presenting the payment option corresponding to the selected piece of the promotion information on the first page; and presenting on the first page the payment option corresponding to the selected piece of the promotion information.

### CROSS-REFERENCE TO RELATED APPLICATIONS

This patent application claims the priority of the Chinese Patent Application No. 201410449762.X, entitled “Information Processing Method, System and Terminal,” filed on Sep. 4, 2014, which is hereby incorporated by reference herein in its entirety.

### TECHNICAL FIELD

In various embodiments, the present disclosure relates to information processing technology, and in particular to an information processing method and device.

### BACKGROUND

As terminals such as mobile phones have become popular portable communication tools, a concept of utilizing the mobile phone as a supplementary payment means or a substitute for a credit card or a wallet appears naturally. In the mobile payment manner, the user of a terminal or the purchaser of a commodity or service pays for the purchased commodity or service by operating the terminal. The user operates the terminal to send a payment instruction generally through the Internet to a financial enterprise such as a bank to launch a currency payment or a capital transfer to realize a mobile payment. As such, it is achieved the integration of the terminal device, the Internet, an application provider and the financial enterprise for financial services including currency payment.

As a new payment manner in which the fee is paid during a transaction activity through a terminal but not with a credit card, the mobile payment has three following features: 1) mobility: services can be achieved portably and movably through the terminal, a consumer thus is freed from going to a distant appointed place to deal with businesses, which breaks the geographic restriction on business halls; 2) real-time performance: the replacement of the conventional manual operation by the interaction between a terminal and an Internet platform realizes a convenient 24-hour payment service, thus, mobile payment is no longer subjected to the business time limits of financial enterprises and shops; moreover, mobile payment enables the consumer to pay for a commodity or service at home, thus avoiding queuing up; 3) quickness: mobile payment also achieves an accurate payment, requiring no change making, thus, mobile payment is a quick multifunctional 24-hour service needing nobody for duty.

### SUMMARY

According to an aspect of the present disclosure, an information processing method is provided. When an application is running on a terminal, at least one piece of promotion information associated with the application is presented on a display screen of the terminal. Upon it is detected one piece of the promotion information is selected, a payment platform which is in-built in the application is triggered to perform the following: requesting a server to determine whether a payment option corresponding to the selected piece of the promotion information shall be presented on a first page or a second page; jumping to the first page upon reception from the server of a first operation instruction of presenting the payment option corresponding to the selected piece of the promotion information on the first page; and presenting on the first page the payment option corresponding to the selected piece of the promotion information.

According to another aspect of the present disclosure, an information processing device is provided, which includes a main body module and a payment module both located at a terminal. The main body module is configured to present on a display screen of a terminal at least one piece of promotion information associated with an application when the application is running on the terminal. The main body module is configured to trigger a payment module which is in-built in the application upon it is detected that one piece of the promotion information is selected. The payment module is configured to: request a server to determine whether a payment option corresponding to the selected piece of the promotion information shall be presented on a first page or a second page; jump to the first page upon reception from the server of a first operation instruction of presenting the payment option corresponding to the selected piece of the promotion information on the first page; and present on the first page the payment option corresponding to the selected piece of the promotion information.

According to still another aspect of the present disclosure, an information processing method is provided. When an application is running on a terminal, at least one piece of promotion information associated with the application is presented on a display screen of the terminal. Upon it is detected one piece of the promotion information is selected, a payment platform which is in-built in the application is triggered to perform the following: determining whether a payment option corresponding to the selected piece of the promotion information shall be presented on a first page or a second page; jumping to the first page upon determining the payment option corresponding to the selected piece of the promotion information shall be presented on the first page; and presenting on the first page the payment option corresponding to the selected piece of the promotion information.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

In the following, embodiments of the present disclosure will be discussed with reference to drawings. It should be understood that the drawings illustrate generally, by way of example, but not by way of limitation, various embodiments discussed in the present disclosure.

FIG. 1-1 shows a payment access process.

FIG. 1-2 shows the structure of an application on a terminal according to a first example of the present disclosure.

FIG. 1-3 is a schematic diagram illustrating a scenario in which a commodity is purchased using an application.

FIG. 1-4 is a schematic diagram illustrating a scenario in which an application provider pushes promotion information to the user.

FIG. 1-5 shows the structure of an application on a terminal according to a second example of the present disclosure.

FIG. 1-6 is a flow chat of an information processing method according to a first embodiment of the present disclosure.

FIG. 1-7 shows the presentation of the promotion information according to an embodiment of the present disclosure.

FIG. 1-8 shows the communication between a terminal and a server according to an embodiment of the present disclosure.

FIG. 1-9 shows the presentation of the promotion information with the ‘gifts for a fixed consumption amount’ mode according to an embodiment of the present disclosure.

FIG. 1-10 shows the presentation of the promotion information with the ‘card binding’ promotion type according to an embodiment of the present disclosure.

FIG. 2-1 is a flow chat of an information processing method according to a second embodiment of the present disclosure.

FIG. 2-2 shows the procedures of S201 in FIG. 2-1.

FIG. 2-3 is a flow chat of an information processing method according to a third embodiment of the present disclosure.

FIG. 3 is a flow chat of an information processing method according to a fourth embodiment of the present disclosure.

### DETAILED DESCRIPTION

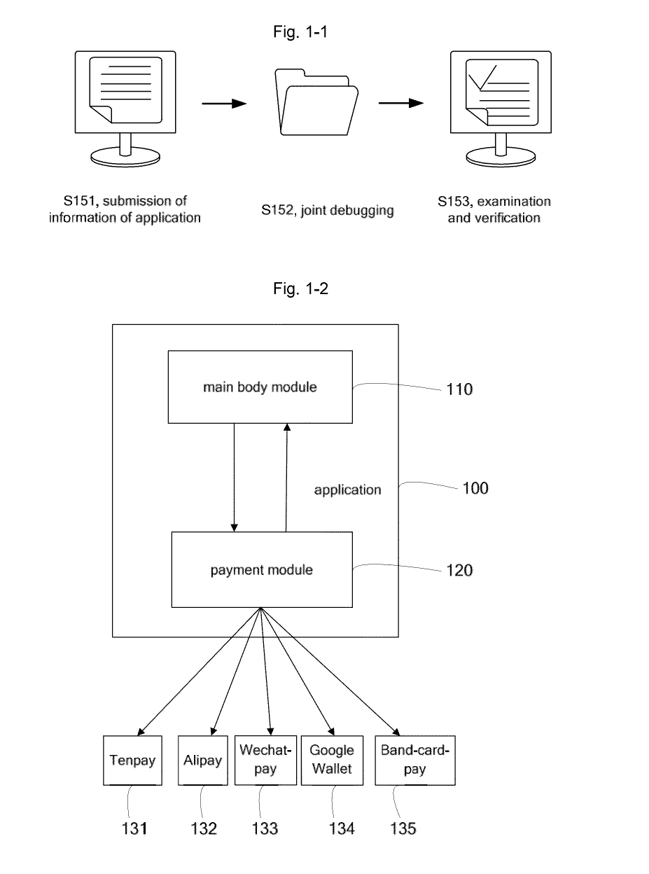

Due to its various advantages, mobile payment is bright in market prospect. It has become such that a mobile payment service provider can independently provide a payment module. The developer of an application can download the payment module from the official website of the mobile payment service provider or from other open platforms and then combine the payment module with his products such as an Application (APP) program (hereinafter referred to as APP), this process is called payment access process, which, as shown in FIG. 1-1, generally includes three following steps.

At S151, the developer of the application provides information of the application to the mobile payment service provider, and then the mobile payment service provider provides the payment module to the developer of the application.

At S152, the developer of the application downloads the program package of the payment module and embeds the program package into the application according to the description of the development document and implements joint debugging in a sandbox environment by means of a joint debugging tool.

At S153, after completing the joint debugging, the developer of the application sends a payment access request to the mobile payment service provider, and the mobile payment service provider examines and verifies payment access request materials from the developer of the application, and the developer of the application can put his product (i.e., the application) on the market after the verification succeeds.

Generally, the payment module provided by a mobile payment service provider integrates or supports a plurality of payment means, including Tenpay, Alipay, bank card payment, Wechat payment, Google Wallet, etc. In other words, merely by embedding a payment module into an application, the developer of the application can connect the application with interfaces for the aforementioned payment means, that is, the embedding of a payment module into an application enables the developer of the application to provide various payment means for the user of the application easily, quickly and conventionally.

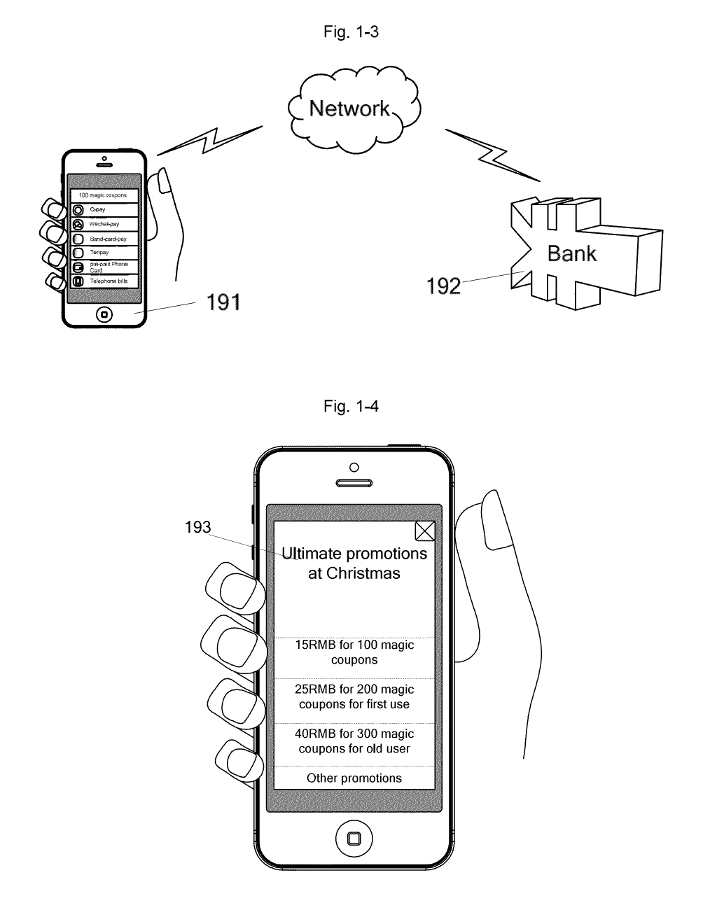

FIG. 1-2 is a schematic diagram illustrating the structural components of an application on a user terminal. As shown in FIG. 1-2, a user downloads an application 100 from an application store and then installs the application 100 on a mobile terminal. The application 100 generally includes two parts: a main body module 110 and a payment module 120. The main body module 110 is developed by the developer of the application while the payment module 120 is provided by a mobile payment service provider. By means of the connection between the payment module 120 with payment means including Tenpay 131, Alipay 132, Wechat-pay 133, Google Wallet 134 and band-card-pay 135, the user can purchase a commodity or service provided by the application. The commodity mentioned here may be a virtual commodity such as game props or an emoticon package for instant chat. FIG. 1-3 is a schematic diagram illustrating a scenario in which a commodity is purchased using an application. As shown in FIG. 1-3, when a user needs to purchase an emoticon for instant chat or game props, the user connects the terminal 191 with a financial enterprise 192 through a payment channel provided by the payment module embedded in the application to complete a payment process. The application on the mobile terminal of the user may be carried by the mobile terminal itself or downloaded by the user from the APP store. The application on the mobile terminal of the user may be a game or a chat application such as Line. However, the user may be unaware that the application includes two parts (main body module and payment module) which are provided by different people or companies or organizations.

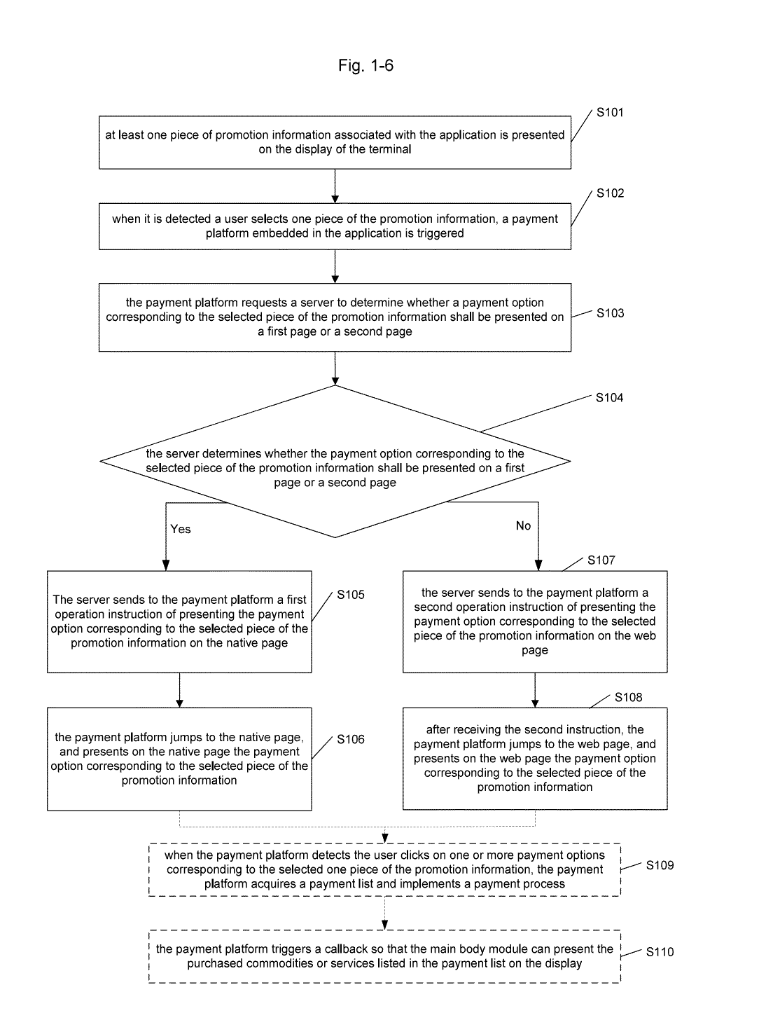

An increasing number of applications on a mobile terminal are embedded with the mobile payment module, and developers of the applications usually push various kinds of promotion information to the user for increasing revenue. As shown in FIG. 1-4, an application provider (which may be the application developer shown in FIG. 1-2) launches promotions at Christmas. The application provider, which provides for example a mobile game, pushes promotion information ‘ultimate promotions at Christmas’ 193 on the mobile phone of the user to attract the user to purchase a commodity or service associated with the mobile game. The promotion information may be generally pushed by a promotion sub-module.

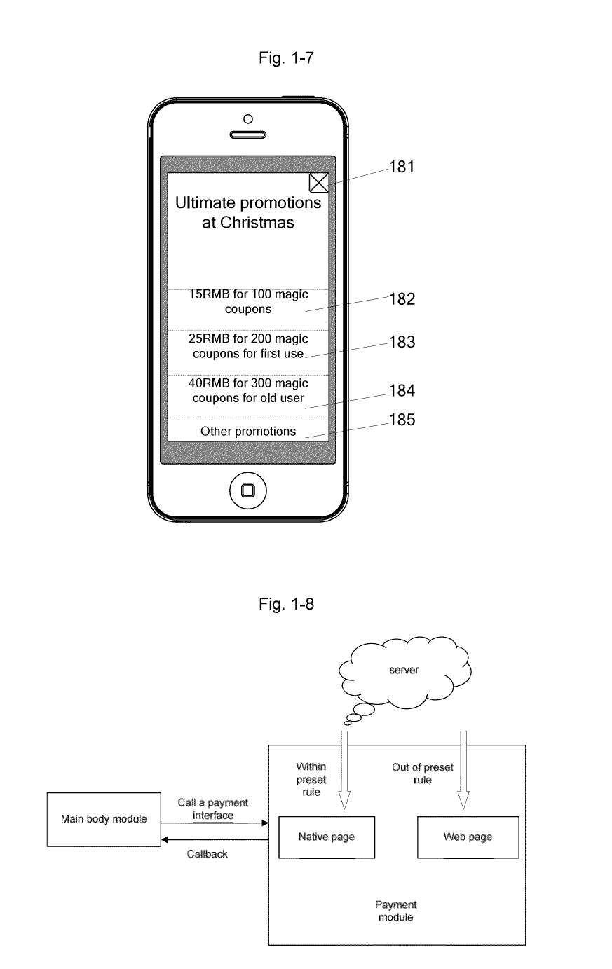

FIG. 1-5 is a second schematic diagram illustrating the structural components of an application on the mobile terminal of a user. As shown in FIG. 1-5, the application 100 includes a main body module 110 and a payment module 120, and the main body module 110 further includes a promotion sub-module 111 which is coupled with the payment module 120. The various payment channels connected with the payment module can be seen from FIG. 1-2.

In the field of such as the game, a promotion mode of propagandizing games (a kind of application) using game promotion information has been accepted by most of game players. The promotion information refers to promotion activity offered by a game developer. For online games installed on a mobile terminal, the promotion of an online game using promotion information has become the main online game operation mode.

The promotion sub-module 111 shown in FIG. 1-5, as the background support for promotion information, is a subprogram written by a program engineer which can be called by a main program developed for a game. The promotion sub-module 111 is designed based on an online game promotion information development platform system (hereinafter referred to as a platform system). When writing a program corresponding to promotion information, the program engineer searches for corresponding modularized codes from a code library, combines the modularized codes, tests the combined codes and finally forms a subprogram which can be called by a main program, that is, forms a promotion sub-module, to realize the activity a program aims for.

To raise revenue by increasing users, the application provider pushes various kinds of promotion information to the users. The inventor finds, during the development of this disclosure, that: as different promotion information corresponds to different promotion sub-modules which are directly related to a payment module (see FIG. 1-5), to meet the need for different promotions or updated promotion, the payment module needs to be updated continuously. The frequent update of the payment module may lead to more frequent change of the version of the application containing the promotion sub-module, which may degrade the robustness of payment. On the other hand, the promotion proposed in many applications cannot be enjoyed by users if the payment module is not updated. For a user, the security of mobile payment is very important when using a mobile payment service. Thus, the user often considers carefully before changing the version of an application. Moreover, frequent change of the version of an application will cause the repeat of downloading an installation program, which troubles the user and consumes significantly the traffic purchased by the user. However, if the version of the application is not updated, the user cannot timely enjoy the promotion, which may degrade user experiment. For the provider of the application, new promotions cannot be timely pushed if the user does not update the version of the application, which may impair the revenue of the provider of the application.

As promotion sub-modules featured in diversity and high iteration speed are directly related to a payment module (refer to FIG. 1-5), the version of the payment module will be updated more and more frequently to match with frequently updated promotion activities, which may undermine the robustness of payment. The following embodiments can slow down the update of a payment module while continuously pushing new promotion information.

### Embodiment 1

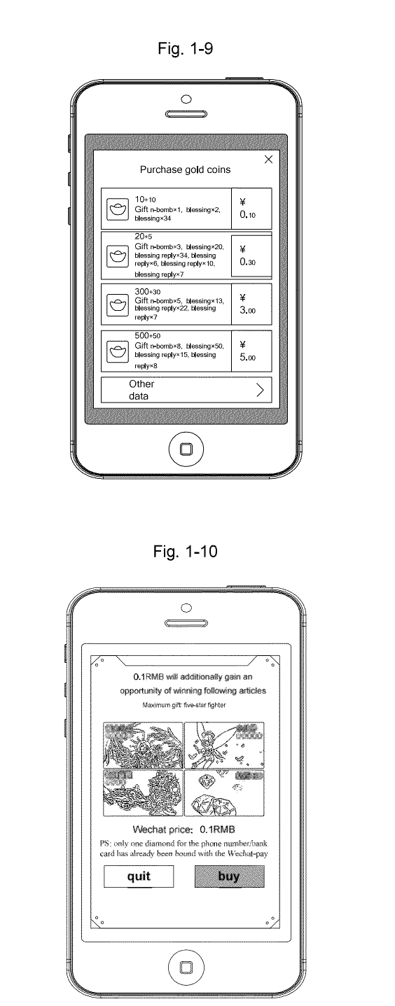

An embodiment of the present disclosure provides an information processing method. Referring to FIG. 1-6, the information processing method includes the following steps.

At S101, when an application is running on a terminal, at least one piece of promotion information associated with the application is presented for example by the main body module on the display screen of the terminal.

The terminal may be a mobile terminal or an immobile terminal. The mobile terminal may include a Smart Phone, a tablet computer, a notebook and a personal digital assistant. The immobile terminal may be a desk-top computer.

The application may include a game application, a chat application (which may be Line, Wechat or Michat), a video application and so on. The application can be downloaded onto a terminal and run on the terminal after being installed on the terminal.

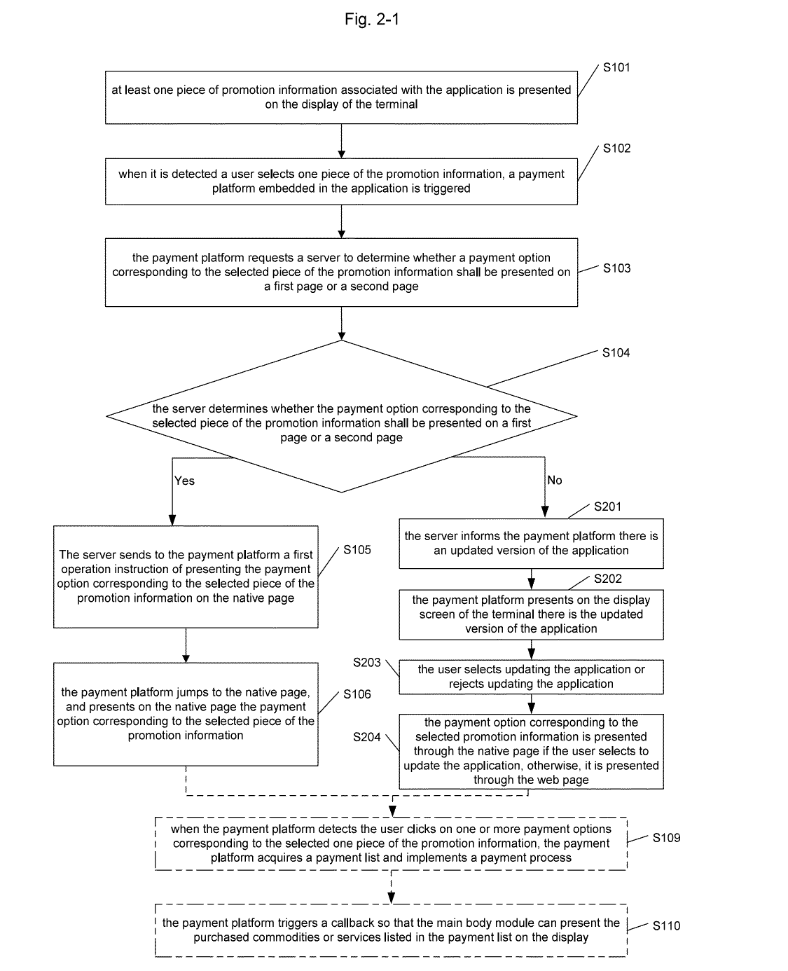

In an example, as shown in FIG. 1-7, a game provider offers various kinds of promotion at Christmas, and four pieces of promotion information are presented in the display area of the display screen, that is, promotion information 182 ‘15 RMB for 100 magic coupons’, promotion information 183 ‘25 RMB for 200 magic coupons for first use’, promotion information 184 ‘40 RMB for 300 magic coupons for old user’ and promotion information 185 ‘other promotions’.

At S102, when for example the main body module detects a user selects one piece of the promotion information, a payment platform embedded in the application is triggered for example by the main body module.

If the user is interested in the promotion activity shown in FIG. 1-7, he/she may click on any piece of the promotion information 182, 183, 184, 185. If the user is not interested in the promotion activity shown in FIG. 1-7, he/she may click on the close control 181.

The payment platform herein may be appreciated as the payment module 120 in FIG. 1-2 or FIG. 1-5.

The payment platform, independent of any bank payment channel, is a third-party electronic payment platform which establishes a relation between the bank payment service and the content service provider, the telecom operator or the technical support provider.

In some examples, the content service provider may be game provider. In some examples, the telecom operator may be China Mobile, China Unicorn or China Telecom. In some examples, the technical support provider may include technology provider such as Microsoft, or financial software provider such as Kingdee and yonyou.

Briefly, the payment platform is a new kind of bank payment channel. As a “Intermediate device” or “technical plugin”, the payment platform provides E-business infrastructure support and application support service for the content service provider, the telecom operator or the technical support provider, and serves as a third party to guarantee the payment associated with various banks. In some examples, the payment platform may be for example Midas offered by Tencent.

It can be understood that the payment platform is a payment interface program, which may be downloaded by a developer of an application from the official website of the mobile payment service provider or from other open platforms. The payment platform is then combined by the developer of the application with his products such as an APP program to form an APP carried with payment function. The payment module provided by a mobile payment service provider integrates or supports a plurality of payment means, including Tenpay, Alipay, bank card payment, Wechat payment, Google Wallet, etc. In other words, merely by embedding a payment module into an application, the developer of the application can connect the application with interfaces for the aforementioned payment means, that is, the embedding of a payment module into an application enables the developer of the application to provide various payment means for the user of the application easily, quickly and conventionally. For example, a mobile game provider embeds the payment platform into the game. Then, users, who downloads the mobile game with the payment function, can buy props of the game through any interfaces provided by the payment platform.

At S103, the payment platform requests a server to determine whether a payment option corresponding to the selected piece of the promotion information shall be presented on a first page or a second page.

The payment option corresponding to the selected piece of the promotion information may include promotion type, gifting protocol, display mode and purchase quantity and will be presented on the display screen by the payment platform.

Here, the first page refers to a page formed through a first call, and the second page refers to a page formed through a second call. For example, the first call may be a local call, and the second call may be a remote call. The local call refers to the call of local elements which are stored in payment platform of the application on the terminal. The remote call refers to the call of elements which are stored in the server via a network.

The remote call may be an H5 call. H5 refers to web pages developed using Hyper Text Markup Language (HTML) 5. In an example, the local call can be realized using a Software Development Kit (SDK).

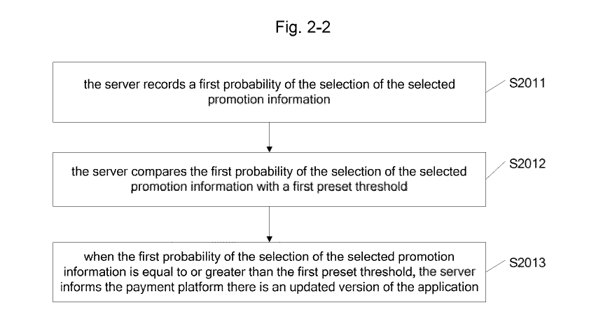

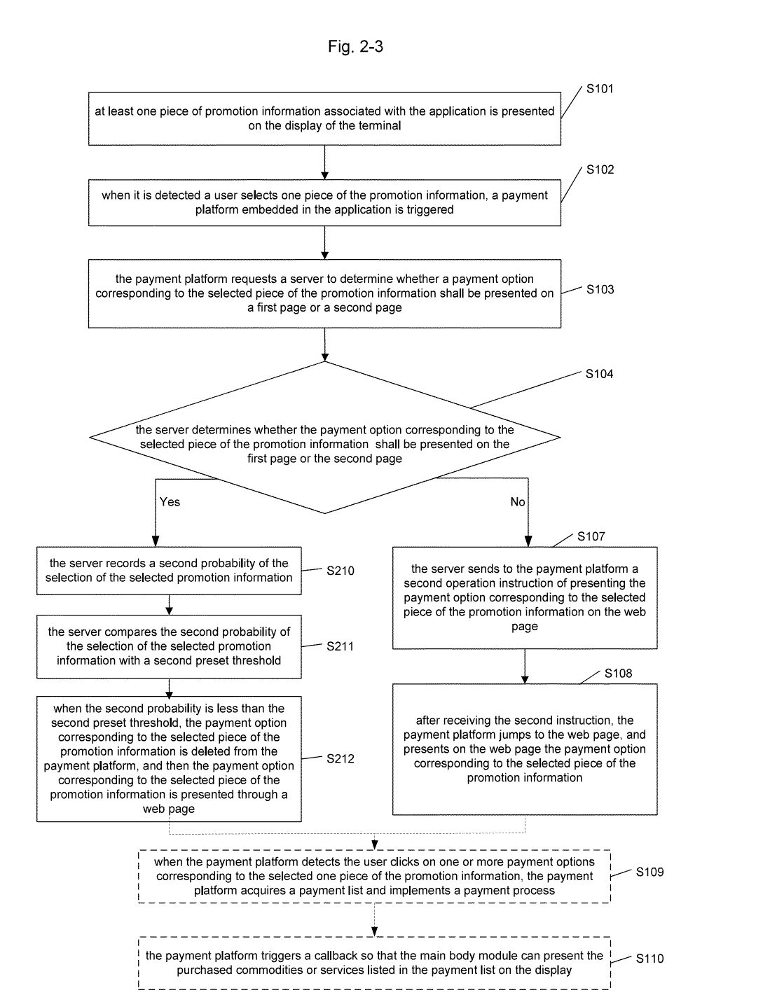

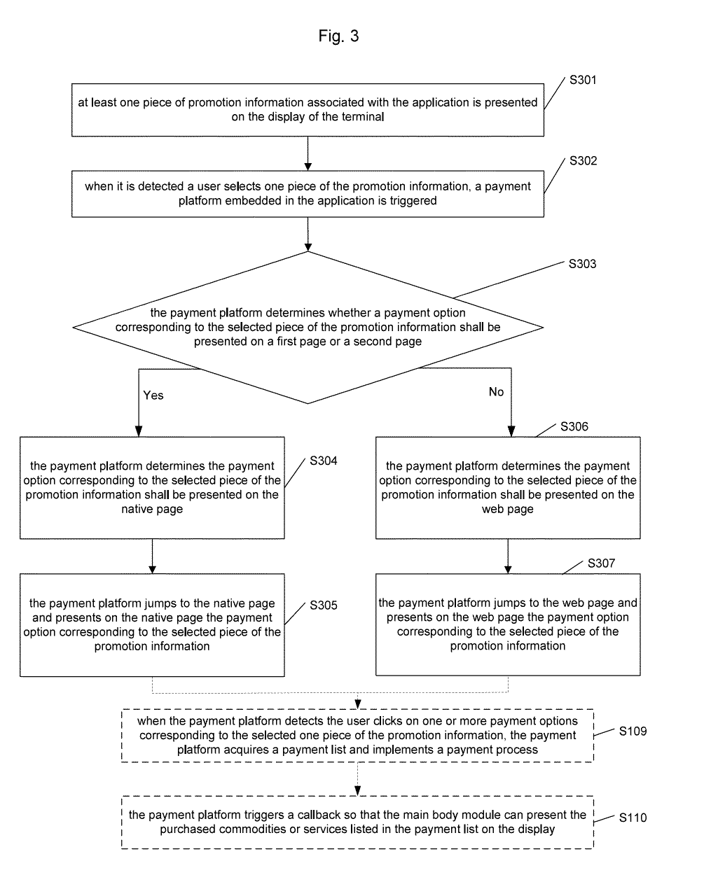

The first page may refer to a native page on the payment platform. The second page may refer to a web page (for example, H5 page). The web page is generated for example by the following way. The server sends an address of the web page to the payment platform (which may be a payment SDK), the payment platform then loads the web page by using the WebView assembly. FIG. 1-9 is an example of the native page, FIG. 1-10 is an example of the web page (H5 page).

At S104, after receiving the request from the payment platform, the server determines whether the payment option corresponding to the selected piece of the promotion information shall be presented on the first page or the second page.

In an example, the request may contain at least one of the following:

the selected promotion information;

an index number corresponding to the selected promotion information; and

the promotion type and the gifting mode corresponding to the selected promotion information.

At S105, when the server determines the payment option corresponding to the selected piece of the promotion information shall be presented on the first page, the server sends to the payment platform a first operation instruction of presenting the payment option corresponding to the selected piece of the promotion information on the native page.

At S106, after receiving the first instruction, the payment platform jumps to the native page, and presents on the native page the payment option corresponding to the selected piece of the promotion information.

At S107, when the server determines the payment option corresponding to the selected piece of the promotion information shall be presented on the second page, the server sends to the payment platform a second operation instruction of presenting the payment option corresponding to the selected piece of the promotion information on the web page (H5 page).

At S108, after receiving the second instruction, the payment platform jumps to the web page, and presents on the web page the payment option corresponding to the selected piece of the promotion information.

In this embodiment, the first page is locally called while the second page is remotely called. Local call requires no download of content such as pattern from a network, and thus is smoother than remote call in user experience. However, with the frequent update of the promotion information, it is necessary to frequently update the version of the application on the terminal, so as to provide updated elements for being locally called. In this way, on the native page it can be presented payment option(s) corresponding to the updated promotion information. The remote call requires the download of content such as pattern from a network, and thus is less smooth in user experience. However, the remote call needs no update of the version of the application and can make payment option(s) corresponding to the updated promotion information presented through a web page, thus freeing the user from updating the version of the application. As can be seen, the embodiment has the advantages of both the local call and remote call.

According to the information processing method provided in the embodiment, the payment option(s) corresponding to the selected promotion information can either be presented through the native page if elements for presenting the payment option(s) corresponding to the selected promotion information have been contained in the payment platform, or presented through the web page if the elements have not been contained in the payment platform, which then can be obtained from the server. In this way, it can be lowered the frequency of update of the payment platform while continuously provide new promotion information.

In some examples, after S106 or S108, the method may further include the following steps.

At S109, when the payment platform detects the user clicks on one or more payment options corresponding to the selected one piece of the promotion information, the payment platform acquires a payment list and implements a payment process.

At S100, the payment platform triggers a callback so that the main body module can present the purchased commodities or services listed in the payment list on the display screen.

The payment list may at least contain a purchase quantity, a unit price and a total price. In some examples, the payment list may further contain the type of a complimentary commodity or service and the quantity of the complimentary commodities or the service life of the complimentary service.

The payment option may include a promotion type, a gifting protocol, a presenting mode and a purchase quantity. The payment option may be shown on the display screen through a payment platform. The presenting mode may indicate how to present the payment options on a page. For example, the presenting mode includes a first presenting mode and a second presenting mode. The first presenting mode may be a plaintext presenting mode, and the second presenting mode may be a presenting mode in which images and animations may be loaded to enrich a present interface. The purchase quantity is generally presented in a pull-down menu or directly input.

The promotion information may include a variety of promotion types, such as, a ‘card binding’ type, an ‘initial charging’ type and a ‘top-up gifts’ type. The card binding refers to the binding of the purchase of a commodity or service using a payment channel with a bank card. The commodity may refer in some examples to game currency or props for a game application, in some other examples may refer to emoticons for a instant chat application. The service may be a Very Important Person (VIP) service or a member service for a video application.

The initial charging may refer to the user makes a deposit in the application for the first time. An application provider often offers a marketing activity or promotion activity for a new user who makes an initial deposit in the application so as to attract the new user. The ‘top-up gifts’ is a very common marketing activity or promotion activity.

Usually, there may be several gifting modes with respect to one promotion type. For example, there are a plurality of gifting modes for the ‘initial charging’ type, including: gifts in proportion, gifts for a fixed consumption amount and extra gifts.

For the ‘top-up gifts’ type, in addition to the foregoing ‘gifts in proportion’, ‘gifts for a fixed consumption amount’ and ‘extra gifts’, the gifting mode may also include ‘gifts for a fixed consumption amount’. An example of the ‘gifts for a fixed consumption amount’ mode can be seen in FIG. 1-9 which exemplifies the charging for gold coins in a game application. In FIG. 1-9, 10 gold coins can be purchased with 0.1 RMB, with 10 gold coins and some props given as gifts, that is, 20 gold coins and some props can be purchased by using 0.1 RMB. 20 gold coins can be purchased with 0.2 RMB, with 5 gold coins and some props given as gifts. 300 gold coins can be purchased with 3 RMB, with 30 gold coins and some props given as gifts. 500 gold coins can be purchased with 5 RMB, with 50 gold coins and some props given as gifts. For the ‘gifts for a certain purchase quantity’ mode, it is typical that gifts are given for a user purchasing a given number of commodities according to a rule after it is determined that the number of the commodities purchased by the user reaches the given number. For example, assume that the commodities purchased by a user are countable and each commodity can be purchased with 1 RMB, according to the gifting rule of 10% gifts for 10 commodities and 20% gifts for 100 commodities, if the user spends 20 RMB, then the number of the purchased commodities is: 10+10*10%+10+10*10%=22. When the user spends 101 RMB, the number of the purchased commodities is: 100+100*20%+1=121.

There is no fixed gifting mode for the ‘card binding’ promotion type. For example, for different game applications, different gifts are offered when the user initially purchases or charges game currency. Referring to FIG. 1-10, the payment of 0.1 RMB will additionally gain an opportunity of winning free props or game equipments, including golden soldier, fairy, steel thunder and diamond. In other examples, for a game YX1, 10 thousand of game coins and a certain game prop can be obtained after an initial charging of 0.1 RMB, for a game YX2, different game props such as cars or airplanes are given as gifts after an initial charging of 1 RMB. Thus, for the ‘card binding’ promotion type, there are various gifting modes, and it is difficult for a payment platform provider to provide a universal module applicable for all developers of applications (such as games) in which the ‘card binding’ promotion type is used. Generally, the developer of a game is also the provider of the game.

The promotion type of promotion information is directly related to the aforementioned local call mode and remote call mode. When the payment platform sends a request to the server, asking the server to determine whether a payment option corresponding to the selected promotion information shall be presented through the native page or the web page, the server first determines whether the payment option corresponding to the selected promotion information meets a preset rule. Generally, the ‘initial charging’ type and the ‘top-up gifts’ type can be realized using a standard module while the ‘card binding’ type and other promotion types defined by application developers according to their promotion needs cannot be realized using a standard module. The standard module refers here to some frequently used universal modularized codes provided by payment service providers. Therefore, as to realization difficulty, the ‘initial charging’ type and a ‘top-up gifts’ type can be covered in the preset rule, however, the preset rule is not limited hereto, a certain promotion type can be covered in the preset rule according to use frequency. Those skilled in the art can is determine the preset rule according to actual conditions.

The preset rule may further include an extension rule to realize, for example, the integrated ‘initial charging’ and ‘top-up gifts’ type. According to this integrated type it may be determined whether the commodities purchased by a user meet a ‘top-up gifts’ condition when the user initially charges his application. If it is determined that the charging is an initial charging operation and the ‘top-up gifts’ condition is met, then it can be determined the payment option corresponding to the promotion information meets an extension rule, that is, meets a preset rule.

The presenting mode is also directly related to the aforementioned local call and remote call. As no bandwidth is consumed in a local call, the first presenting mode may be adopted, and as it is needed to download pattern content from a network in the remote call mode, the second presenting mode may be adopted to guarantee smoothness.

In the embodiment, S101-S103, S106 and S108-S100 are executed at a terminal side, while S104-S105 and S107 are executed at a server side. As stated before, after an application is downloaded onto the terminal, the main body module of the application can call a payment module (refer to FIG. 1-2 or FIG. 1-5 or FIG. 1-8). The payment module may also be called as the payment platform.

### Embodiment 2

An embodiment of the present disclosure provides an information processing method. Referring to FIG. 2-1, the information processing method includes the following steps.

At S101, when an application is running on a terminal, at least one piece of promotion information associated with the application is presented for example by the main body module on the display screen of the terminal.

At S102, when for example the main body module detects a user selects one piece of the promotion information, a payment platform embedded in the application is triggered for example by the main body module.

At S103, the payment platform requests a server to determine whether a payment option corresponding to the selected piece of the promotion information shall be presented on a first page or a second page.

At S104, after receiving the request from the payment platform, the server determines whether the payment option corresponding to the selected piece of the promotion information shall be presented on a first page or a second page.

At S105, when the server determines the payment option corresponding to the selected piece of the promotion information shall be presented on the first page, the server sends to the payment platform a first operation instruction of presenting the payment option corresponding to the selected piece of the promotion information on the native page.

At S106, after receiving the first instruction, the payment platform jumps to the native page, and presents on the native page the payment option corresponding to the selected piece of the promotion information.

At S201, when the server determines the payment option corresponding to the selected piece of the promotion information shall be presented on the second page, the server informs the payment platform there is an updated version of the application.

At S202, the payment platform presents on the display screen of the terminal there is the updated version of the application.

At S203, the user selects updating the application or rejects updating the application.

At S204, upon it is detected the user selects to update the application, it is downloaded from the server the updated version of the application, so as to update the application. After the application is updated, it means the selected promotion information is incorporated in the updated application, so the payment option corresponding to the selected promotion information can be presented through the native page.

Upon it is detected the user rejects to update the application, the payment option corresponding to the selected promotion information is presented through the web page.

In some examples, S201 may include the following step (see FIG. 2-2).

At S2011, the server records a first probability of the selection of the selected promotion information.

At S2012, the server compares the first probability of the selection of the selected promotion information with a first preset threshold.

At S2013, when the first probability of the selection of the selected promotion information is equal to or greater than the first preset threshold, the server informs the payment platform there is an updated version of the application. Otherwise, the server does not inform the payment platform there is an updated version of the application.

In some examples, the first probability of the selection of the selected promotion information may be the frequency the user of the terminal selects the selected promotion information. In some other examples, the first probability of the selection of the selected promotion information may be a general probability from the server which indicates the probability of the selection of the selected promotion information by all users.

As can be seen, in this embodiment, it is implemented the conversion from the web page to the native page. In some examples, when the first probability of the selection of the selected promotion information is high (no less than the first preset threshold), it is converted from the web page to the native page. Note that, the conversion from the web page to the native page can improve the loading speed of page. As mentioned before, the loading speed of the native page is greater than that of the web page.

### Embodiment 3

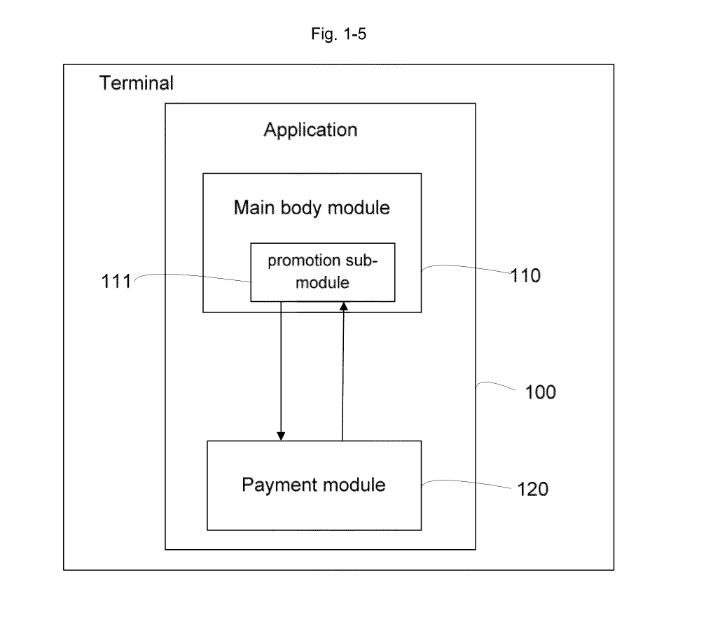

An embodiment of the present disclosure provides an information processing method. Referring to FIG. 2-3, the information processing method includes the following steps.

At S101, when an application is running on a terminal, at least one piece of promotion information associated with the application is presented for example by the main body module on the display screen of the terminal.

At S102, when for example the main body module detects a user selects one piece of the promotion information, a payment platform embedded in the application is triggered for example by the main body module.

At S103, the payment platform requests a server to determine whether a payment option corresponding to the selected piece of the promotion information shall be presented on a first page or a second page.

At S104, after receiving the request from the payment platform, the server determines whether the payment option corresponding to the selected piece of the promotion information shall be presented on the first page or the second page.

At S210, when the server determines the payment option corresponding to the selected piece of the promotion information shall be presented on the first page, the server records a second probability of the selection of the selected promotion information.

At S211, the server compares the second probability of the selection of the selected promotion information with a second preset threshold.

At S212, when the second probability of the selection of the selected promotion information is less than the second preset threshold, the payment option corresponding to the selected piece of the promotion information is deleted from the payment platform, and then the payment option corresponding to the selected piece of the promotion information is presented through a web page.

As can be seen, in this embodiment, it is implemented the conversion from the native page to the web page. In some examples, when the second probability of the selection of the selected promotion information is low (less than the second preset threshold), it is converted from the native page to the web page. Note that, the conversion from the native page to the web page can save native resources. The payment option corresponding to the selected piece of the promotion information which is selected rarely is deleted from the payment platform while stored in the server, so as to save native resources.

In some example, the second page (i.e., web page) may be H5 page. For example, in an Andriod system, the web page is loaded by using WebView assembly. Different game applications have different styles, the designs and layouts of web pages thus are also different. When an application is started up, the payment module acquires and sends the ID of the application to the server, the server sends an operation instruction carrying the address of an H5 page to the terminal, the payment module loads and presents the H5 page according to the address of the H5 page.

Usually, the H5 page has an interface connected with the payment module. For example, there is a button “Pay” on the H5 page. When the user clicks on the button “Pay”, the H5 page calls the function stored in the payment module, so as to implement the payment.

### Embodiment 4

An embodiment of the present disclosure provides an information processing method. Referring to FIG. 3, the information processing method includes the following steps.

At S301, when an application is running on a terminal, at least one piece of promotion information associated with the application is presented for example by the main body module on the display screen of the terminal.

At S302, when for example the main body module detects a user selects one piece of the promotion information, a payment platform embedded in the application is triggered for example by the main body module.

At S303, the payment platform determines whether a payment option corresponding to the selected piece of the promotion information shall be presented on a first page or a second page.

At S304, when it is determined the payment option corresponding to the selected piece of the promotion information shall be presented on the first page, the payment platform determines the payment option corresponding to the selected piece of the promotion information shall be presented on the native page.

At S305, the payment platform jumps to the native page and presents on the native page the payment option corresponding to the selected piece of the promotion information.

At S306, when it is determined the payment option corresponding to the selected piece of the promotion information shall be presented on the second page, the payment platform determines the payment option corresponding to the selected piece of the promotion information shall be presented on the web page.

At S307, the payment platform jumps to the web page and presents on the web page the payment option corresponding to the selected piece of the promotion information.

As can be seen, in this embodiment, all steps (S301-S307) are executed at the terminal.

In this embodiment, it is also able to implement the conversion from the web page to the native page or the conversion from the native page to the web page. The procedures for the conversion from the web page to the native page can be deduced based on the second embodiment, and the procedures for the conversion from the native page to the web page can be deduced based on the third embodiment.

As can be appreciated, every module/unit in a terminal can be implemented by the processor in the terminal, or by a specific logic circuit. For example, it can be implemented by CPU, MPU, DSP or FPGA.

As also can be appreciated, every module/unit in a server can be implemented by the processor in the server, or by a specific logic circuit. For example, it can be implemented by CPU, MPU, DSP or FPGA.

When implemented in form of a software functional module and sold or used as an independent product, a module/unit of an embodiment of the present disclosure may also be stored in a non-transitory computer-readable storage medium. Based on such an understanding, the essential part or a part of the technical solution of an embodiment of the present disclosure contributing to prior art may appear in form of a software product, which software product is stored in storage media, and includes a number of instructions for allowing a computer equipment (such as a personal computer, a server, a network equipment, or the like) to execute all or part of the methods in various embodiments of the present disclosure. The storage media include various media that can store program codes, such as a U disk, a mobile hard disk, a Read-Only Memory (ROM), a magnetic disk, a CD, and the like. Thus, an embodiment of the present disclosure is not limited to any specific combination of hardware and software.

Accordingly, an embodiment of the present disclosure further provides a non-transitory computer storage medium storing instructions (which may be executed by a processing circuit) thereon for executing any information processing method according to any embodiment of the present disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

While the foregoing disclosure discusses illustrative aspects and/or embodiments, it should be noted that various changes and modifications could be made herein without departing from the scope of the described aspects and/or embodiments as defined by the appended claims.

1. A method, comprising:
presenting on a display screen of a terminal at least one piece of promotion information associated with an application when the application is running on the terminal;
upon detecting that one piece of the promotion information is selected, triggering a payment platform which is in-built in the application to perform the following:
requesting a server to determine whether a payment option corresponding to the selected piece of the promotion information shall be presented on a first page or a second page;
jumping to the first page upon reception from the server of a first operation instruction of presenting the payment option corresponding to the selected piece of the promotion information on the first page; and
presenting on the first page the payment option corresponding to the selected piece of the promotion information.

2. The method according to claim 1, further comprising:
jumping to the second page upon reception from the server of a second operation instruction of presenting the payment option corresponding to the selected piece of the promotion information on the second page; and
presenting on the second page the payment option corresponding to the selected piece of the promotion information.

3. The method according to claim 1, wherein the first page is a native page contained in the payment platform, the second page is a web page from the server.

4. The method according to claim 2, further comprising:
determining, by the server, whether the payment option corresponding to the selected piece of the promotion information shall be presented on the first page or the second page upon reception of the request from the payment platform;
when it is determined the payment option corresponding to the selected piece of the promotion information shall be presented on the first page, sending, by the server, the first operation instruction to the terminal;
when it is determined the payment option corresponding to the selected piece of the promotion information shall be presented on the second page, sending, by the server, the second operation instruction to the terminal.

5. The method according to claim 4, further comprising: when it is determined the payment option corresponding to the selected piece of the promotion information shall be presented on the second page,
informing, by the server, the payment platform there is an updated version of the application,
upon detecting a selection of updating the application, downloading, by the payment platform, from the server an updated version of the application which contain the selected piece of the promotion information; and
presenting on the first page the payment option corresponding to the selected piece of the promotion information.

6. A device, comprising: a main body module and a payment module both located at a terminal;
wherein the main body module is configured to present on a display screen of a terminal at least one piece of promotion information associated with an application when the application is running on the terminal,
wherein the main body module is configured to trigger a payment module which is in-built in the application upon it is detected that one piece of the promotion information is selected,
wherein the payment module is configured to:
request a server to determine whether a payment option corresponding to the selected piece of the promotion information shall be presented on a first page or a second page;
jump to the first page upon reception from the server of a first operation instruction of presenting the payment option corresponding to the selected piece of the promotion information on the first page; and
present on the first page the payment option corresponding to the selected piece of the promotion information.

7. The device according to claim 6, wherein the payment module is further configured to:
jump to the second page upon reception from the server of a second operation instruction of presenting the payment option corresponding to the selected piece of the promotion information on the second page; and
present on the second page the payment option corresponding to the selected piece of the promotion information.

8. The device according to claim 6, wherein the first page is a native page contained in the payment module, the second page is a web page from the server.

9. The device according to claim 7, further comprising:
a first determining module at the server, configured to determine whether the payment option corresponding to the selected piece of the promotion information shall be presented on the first page or the second page upon reception of the request from the payment module;
a first sending module at the server, configured to send the first operation instruction to the payment module when the first determining module determines the payment option corresponding to the selected piece of the promotion information shall be presented on the first page, or to send the second operation instruction to the payment module when the payment option corresponding to the first determining module determines the selected piece of the promotion information shall be presented on the second page.

10. The device according to claim 9, further comprising an informing module at the server, configured to inform the payment module there is an updated version of the application, when the first determining module at the server determines the payment option corresponding to the selected piece of the promotion information shall be presented on the second page,
wherein the payment m is further configured to: upon detecting a selection of updating the application, download from the server an updated version of the application which contain the selected piece of the promotion information, and presenting on the first page the payment option corresponding to the selected piece of the promotion information.

11. A non-transitory computer-readable storage medium storing instructions thereon for execution by at least one processing circuit, the instructions comprising:
presenting on a display screen of a terminal at least one piece of promotion information associated with an application when the application is running on the terminal;
upon detecting that one piece of the promotion information is selected, triggering a payment platform which is in-built in the application to perform the following:
requesting a server to determine whether a payment option corresponding to the selected piece of the promotion information shall be presented on a first page or a second page;
jumping to the first page upon reception from the server of a first operation instruction of presenting the payment option corresponding to the selected piece of the promotion information on the first page; and
presenting on the first page the payment option corresponding to the selected piece of the promotion information.

12. The non-transitory computer-readable storage medium according to claim 11, wherein the instructions further comprises:
jumping to the second page upon reception from the server of a second operation instruction of presenting the payment option corresponding to the selected piece of the promotion information on the second page; and
presenting on the second page the payment option corresponding to the selected piece of the promotion information.

13. The non-transitory computer-readable storage medium according to claim 11, wherein the first page is a native page contained in the payment platform, the second page is a web page from the server.

14. The non-transitory computer-readable storage medium according to claim 12, wherein the instructions further comprises:
determining, at the server, whether the payment option corresponding to the selected piece of the promotion information shall be presented on the first page or the second page upon reception of the request from the payment platform;
when it is determined the payment option corresponding to the selected piece of the promotion information shall be presented on the first page, sending the first operation instruction from the server to the terminal;
when it is determined the payment option corresponding to the selected piece of the promotion information shall be presented on the second page, sending the second operation instruction from the server to the terminal.

15. The non-transitory computer-readable storage medium according to claim 14, wherein the instructions further comprises:
when it is determined the payment option corresponding to the selected piece of the promotion information shall be presented on the second page,
informing, by the server, the payment platform there is an updated version of the application,
upon detecting a selection of updating the application, downloading, by the payment platform, from the server an updated version of the application which contain the selected piece of the promotion information; and
presenting on the first page the payment option corresponding to the selected piece of the promotion information.

16. A method, comprising:
presenting on a display screen of a terminal at least one piece of promotion information associated with an application when the application is running on the terminal;
upon detecting that one piece of the promotion information is selected, triggering a payment platform which is in-built in the application to perform the following:
determining whether a payment option corresponding to the selected piece of the promotion information shall be presented on a first page or a second page;
jumping to the first page upon determining the payment option corresponding to the selected piece of the promotion information shall be presented on the first page; and
presenting on the first page the payment option corresponding to the selected piece of the promotion information.

17. The method according to claim 16, further comprising:
jumping to the second page upon determining the payment option corresponding to the selected piece of the promotion information shall be presented on the second page; and
presenting on the second page the payment option corresponding to the selected piece of the promotion information.

18. The method according to claim 16, wherein the first page is a native page contained in the payment platform, the second page is a web page from the server.

19. The method according to claim 17, further comprising:
determining whether the payment option corresponding to the selected piece of the promotion information shall be presented on the first page or the second page;
when it is determined the payment option corresponding to the selected piece of the promotion information shall be presented on the first page, determining the payment option corresponding to the selected piece of the promotion information shall be presented on the first page;
when it is determined the payment option corresponding to the selected piece of the promotion information shall be presented on the second page, determining the payment option corresponding to the selected piece of the promotion information shall be presented on the second page.
